(19) United States
(12) Patent Application Publication
(10) Pub. No.: US 2015/0142305 A1
(43) Pub. Date: May 21, 2015

(54) NAVIGATION APPARATUS

(71) Applicant: DENSO CORPORATION, Kariya-city, Aichi-pref. (JP)

(72) Inventor: Shunitsu Kubo, Anjo-city (JP)

(21) Appl. No.: 14/411,400

(22) PCT Filed: Jul. 29, 2013
(86) PCT No.: PCT/JP2013/004580

§ 371 Date: Dec. 26, 2014

(30) Foreign Application Priority Data
Aug. 2, 2012 (JP) 2012-172228

(51) Int. Cl. G01C 21/36; B60L 3/12; G01C 21/34; B60L 11/18

(52) U.S. Cl. CPC G01C 21/3697; B60L 11/1861; B60L 3/12; G01C 21/3469; B60L 2260/52; B60L 2260/54
USPC 701/439

(57) ABSTRACT

A navigation apparatus utilized in an electric vehicle includes a position obtaining section subsequently obtaining present position of the electric vehicle, a display controller displaying an electronic map on a display device, an available travel range calculation section, an estimation available travel range calculation section, and a progress calculation section calculating progress of the available travel range relative to the estimation available travel range. The available travel range is available travel distance or available travel time that can be traveled with remaining power of the travelling battery. The display controller displays light beam locus having sector-like shape on the electronic map with the present position as a base in a travelling direction, and changes a length of the light beam locus in the travelling direction corresponding to progress of the available travel range under a condition that the light beam locus is entirely displayed on the display device.

### CROSS REFERENCE TO RELATED APPLICATION

This application is based on Japanese Patent Application No. 2012-172228 filed on Aug. 2, 2012, the disclosure of which is incorporated herein by reference.

### TECHNICAL FIELD

The present disclosure relates to a navigation apparatus utilized in an electric vehicle.

### BACKGROUND ART

Conventional art discloses a navigation apparatus that displays an available travel distance of an electric vehicle on an electronic map.

For example, patent literature 1 discloses a technology of displaying the available travel distance of the electric vehicle. In patent literature 1, an available travel range of the electric vehicle is displayed on the electronic map as a circular shape with the vehicle as a center of the circle. In the technology of patent literature 1, when all of the boundary of the available travel range of the electric vehicle cannot be displayed in a display area (that is, a display window) of a display screen, a frame indicating a position of a hidden boundary is displayed on the display area. When the frame is selected by a user, an electronic map of the hidden boundary, which corresponds to the selected frame, is displayed under an available maximum display scale.

Patent literature 2 discloses a technology of displaying an available travel range by displaying a reachable point on a guidance route to a destination.

However, the technology disclosed in patent literature 1 lacks in convenience for ordinary use as the following. The user has to perform an operation in order to display entire boundary of the available travel range on the display window. Further, when the hidden boundary corresponding to the frame is selected by the user, the scale of the electronic map is automatically changed to a maximum scale that enables a display of the entire boundary on the display window. Thus, a maximum scale enabling entire display of a relatively broad available travel range is smaller than a maximum scale enabling entire display of a relatively small available travel range. Thus, the display of the electronic map cannot be performed under a scale preferred by the user.

As shown in the technology of patent literature 1, when the available travel range is displayed on the electronic map as the circular shape having a dimension corresponding to an actual distance with the vehicle as the center, the user may feel great psychological burden. Specifically, as described above, the available travel range is displayed around the vehicle with an azimuth angle range of 360 degrees. Thus, the user may feel great psychological burden when determining a direction which enables an increase of the available travel distance.

As shown in the technology of patent literature 2, when the available travel range is displayed only on the guidance route to the destination, the user may feel less psychological burden for determining a direction which enables an increase of the available travel distance. However, when the vehicle departs from the guidance route, the user may feel great psychological burden for determining the direction which enables an increase of the available travel distance. Thus, a road to be traveled by the vehicle is limited. Thus, the technology related to patent literature 2 also lacks in convenience for the user.

### PRIOR ART LITERATURES

### Patent Literature

[Patent literature 1] JP 2010-169423 A

[Patent literature 2] JP 2010-286400 A

### SUMMARY OF INVENTION

In view of the foregoing difficulties, it is an object of the present disclosure to provide a navigation apparatus which reduces psychological burden of a user who drives an electric vehicle with consideration of an available travel distance and available travel time and restricts degradation in convenience of use.

According to an aspect of the present disclosure, a navigation apparatus utilized in an electric vehicle, which includes a motor and a travelling battery supplying power to the motor, includes a position obtaining section, a display controller, an available travel range calculation section, an estimation available travel range calculation section, and a progress calculation section. The position obtaining section subsequently obtains a present position of the electric vehicle. The display controller displays an electronic map on a display window of a display device. The available travel range calculation section calculates an available travel range of the electric vehicle at the present position. The available travel range is at least one of an available travel distance that the electric vehicle is able to travel with a remaining power of the travelling battery or an available travel time that the electric vehicle is able to travel with the remaining power of the travelling battery. The estimation available travel range calculation section calculates an estimation available travel range of the electric vehicle at the present position. The estimation available travel range is calculated based on the available travel range of the electric vehicle at a departure point of the electric vehicle. The departure point is a place from where the electric vehicle starts a travelling. The progress calculation section calculates an increase amount or a decrease amount of the available travel range at the present position with respect to the estimation available travel range. The display controller displays a light beam locus on the electronic map in an overlapped manner with the present position of the electric vehicle as a base. The light beam locus has a sector-like shape spreading along a travelling direction of the electric vehicle. The sector-like shape is similar to a shape generated by lights when the lights emitted from a point light source are projected on a road surface in front of the electric vehicle. The display controller changes, regardless of a scale of the electronic map, a length of the light beam locus in the travelling direction corresponding to the increase amount or the decrease amount of the available travel range calculated by the progress calculation section under a condition that the light beam locus is entirely displayed on the display window of the display device.

With above navigation apparatus psychological burden of a user who drives an electric vehicle with consideration of an available travel distance and available travel time is reduced, and at the same time, degradation in convenience of use for the user is restricted.

### BRIEF DESCRIPTION OF DRAWINGS

The above and other objects, features and advantages of the present invention will become more apparent from the following detailed description made with reference to the accompanying drawings. In the drawings:

FIG. 1 is a block diagram showing a configuration of a navigation apparatus according to a first embodiment of the present disclosure;

FIG. 2 is a block diagram showing an example of a navigation related functional configuration of a control unit;

FIG. 3 is a flowchart showing an example of a route guidance process executed by the control unit of an electric vehicle;

FIG. 4 is a sub flowchart showing an example of a first display process;

FIG. 5 is a diagram showing a display example in which an estimated depletion time of remaining power of a battery for traveling is displayed overlapped with an area display of a light beam locus;

FIG. 6 is a sub flowchart showing an example of a second display process;

FIG. 7 is diagram showing a display example in which progress information, a travel distance and a travel time to a branch point, a direction on which the branch point is disposed are displayed overlapped with an area display of a light beam locus;

FIG. 8 is a diagram showing an example of an area display having a shape of light beam locus;

FIG. 9 is a flowchart showing an example of a guidance process related to a guidance to a charging station and executed by a control unit; and

FIG. 10 is a diagram showing a display example in which an area display of a light beam locus for charging is displayed.

### EMBODIMENTS FOR CARRYING OUT INVENTION

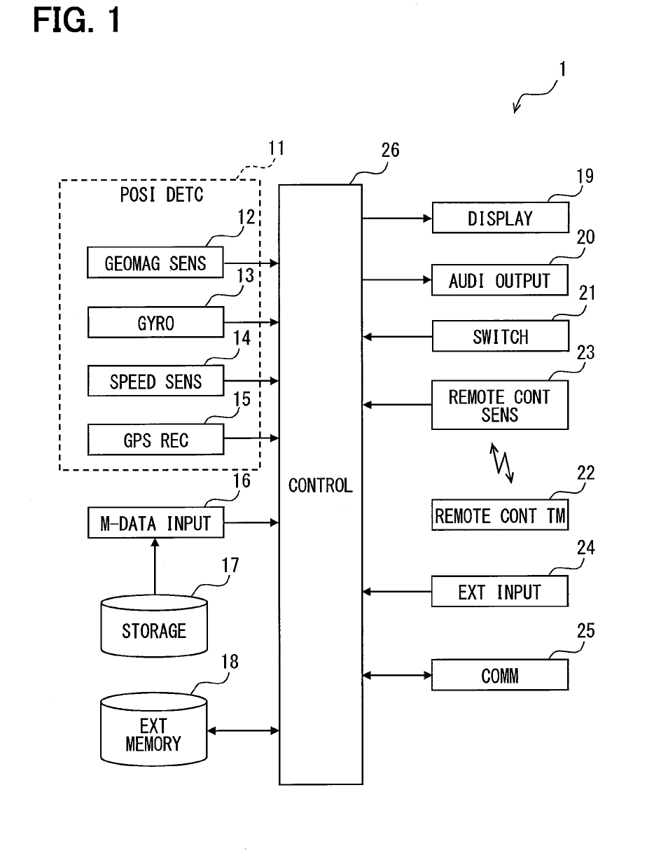

The following will describe embodiments of the present disclosure with reference to the drawings. As shown in FIG. 1, a navigation apparatus 1 is equipped to an electric vehicle, and has a navigating function, such as retrieving a route and giving guidance instructions to the retrieved route. Herein, electric vehicle (EV) is a vehicle which travels with only an electric motor (motor) as a driving source for travelling. The electric vehicle receives power from an external power source, and charges a travelling battery, which supplies power to the motor, with the power received from the external power source. The present disclosure may also be applied to a plug-in hybrid vehicle (PHV) which has both the motor and an engine as driving sources for travelling.

As shown in FIG. 1, the navigation apparatus 1 includes a position detector (POSI DETC) 11, a map data input unit (M-DATA IN) 16, a storage (STORAGE) 17, an external memory (EXT MEMORY) 18, a display device (DISPLAY) 19, an audio output unit (AUDI OUTPUT) 20, an operation switch group (SW) 21, a remote control terminal (REMOTE CONT TM) 22, a remote control terminal sensor (REMOTE CONT SENS) 23, an external input unit (EXT INPUT) 24, a communication device (COMM) 25, and a controller (CONTROL) 26.

The position detector 11 includes a well-known geomagnetic sensor (GEOMAG SENS) 12, a gyroscope (GYRO) 13, a speed sensor (SPEED SENS) 14 that calculates a vehicle speed, and a GPS receiver (GPS REC) 15 used in a global positioning system (GPS) for detecting a position of the vehicle based on radio waves from a satellite. The position detector 11 subsequently detects a present position of the vehicle and subsequently detects a travelling direction of the vehicle. The position detector 11 may include a distance sensor instead of the speed sensor 14. For example, the present position of the vehicle may be indicated by a coordinate including latitude and longitude, and the travelling direction of the vehicle may be indicated by an azimuth angle with north direction as a reference. Hereinafter, the present position of the vehicle is also referred to as a vehicle position.

Each of the geomagnetic sensor 12, the gyroscope 13, the speed sensor 14, and the GPS receiver 15 included in the position detector 11 has an instrumental error different from each other. Thus, the multiple sensors included in the position detector 11 may be used in a complementary manner. Alternatively, the position detector 11 may include a part of the above-described sensors based on an accuracy of each sensor.

The map data input unit 16 inputs map data necessary for drawing of the electronic map to the controller 26. The map data includes road data including node data and link data, background data indicating a landform, and text data indicating a name of a place. The map data unit 16 is connected with a storage 17 that stores the map data. The storage 17 may be provided by a Compact Disc Read Only Memory (CD-ROM), a Digital Versatile Disk Read Only Memory (DVD-ROM), a memory card, a Hard Disk Drive (HDD) or the like.

The link connects adjacent nodes when a road on the electronic map is divided by nodes, such as an intersection, a branch point, and/or a join point. The link data includes a link ID, which is a predetermined number for identifying a link, a link length indicating a length of a link, a link direction, a link azimuth, coordinates (latitude and longitude) of a link start and a link end, a road name, a one-way regulation of a road, or the like.

The node data includes a node ID, which is a predetermined number assigned to a node, a node coordinate, a node name, a connection link ID that is an ID of a link connected to the node, or the like.

The background data correlates each facility and landform on the map to a corresponding coordinate (latitude and longitude) on the map. The facility data includes a type of the facility and a name of the facility. In the present embodiment, the facility data includes a coordinate of the charging station and a name of the charging station. The charging station is a place which provides a charging service for charging the travelling battery of the electric vehicle. The charging station is also referred to as a charging facility.

The external memory 18 is provided by a writable large-capacity storage, such as a HDD. The external memory 18 stores large capacity of data and data that need to be maintained even when the external memory 18 is powered off. The external memory 18 may copy a frequently used data from the map data input unit 16 and use the copied data. The external memory 18 may also be provided by a removable memory that has a relatively small capacity.

The display device 19 displays an electronic map for guiding the vehicle to travel, a destination selection window or the like. For example, the display device 19 may be provided by a display screen that supports a color display, such as a liquid crystal display screen, an organic EL display screen, plasma display screen or the like. The audio output unit 20 is provided by a speaker, and outputs, based on an instruction of the controller 26, an audio guidance during the route guidance.

The operation switch group 21 includes, as an example, a touch switch that is integrated with the display device 19 or a mechanical switch. An instruction for activating the controller 26 to execute each function is input to the navigation apparatus by operating the operation switch group 21. The operation switch group 21 includes a switch used for setting a departure point and a destination. By operating the switch, the user is able to set the departure point and the destination based on preliminarily registered places, facility names, phone numbers, and addresses.

The remote control terminal 22 includes multiple operation switches (not shown). When the switch is operated, the remote control terminal 22 inputs an instruction signal to the controller 26 by the remote control terminal sensor 23. Thus, the remote control terminal 22 is able to instruct the controller 26 to execute the functions, similar to the operation switch group 21.

The external input unit 24 is an interface by which the controller 26 acquires vehicle state data from Electronic Control Units (ECU) equipped to the vehicle or sensors equipped to the vehicle. The vehicle state data includes the vehicle speed, a state of charge (SOC) of the travelling battery of the vehicle and the like. For example, the external input unit 24 receives the vehicle state data transmitted from the vehicle-equipped ECUs and the vehicle-equipped sensors through an in-vehicle local area network (LAN). The LAN may be a network operating based on a communication protocol, such as a controller area network (CAN).

The communication device 25 receives road traffic information distributed by a center of Vehicle Information and Communication System (VICS) (registered trademark) through a network, a beacon disposed along the road, or a frequency modulation (FM) broadcasting station of each area. The communication device 25 receives high-accuracy map data distributed by an Advanced Driver Assist Systems (ADAS) Horizon distribution server through the network, the beacon disposed along the road, or the FM broadcasting station of each area.

The map data of the ADAS Horizon enables a pre-reading of a road property within an area that cannot be sensed by a vehicle sensor, such as a radar or a camera. For example, map data of the ADAS Horizon includes road property data, such as a curvature of a curve on the road (for example, as a link), road width, road slope, the number of traffic lanes of the road, a speed limit, and road class. The communication device 25 may include a specific device corresponding to a device type of a direct communication partner.

The controller 26 is provided by an ordinary computer, and includes a well-known central processing unit (CPU), a read only memory (ROM), a random access memory (RAM), a memory, an input/output (I/O), and a bus line that connects the above-described parts (the parts of the controller are not shown in the drawings). The controller 26 executes various processes in order to achieve the navigation function based on information transmitted from the position detector 11, from the map data input unit 16, from the external memory 18, from the operation switch group 21, from the remote control terminal sensor 23, from the external input unit 24, and from the communication device 25.

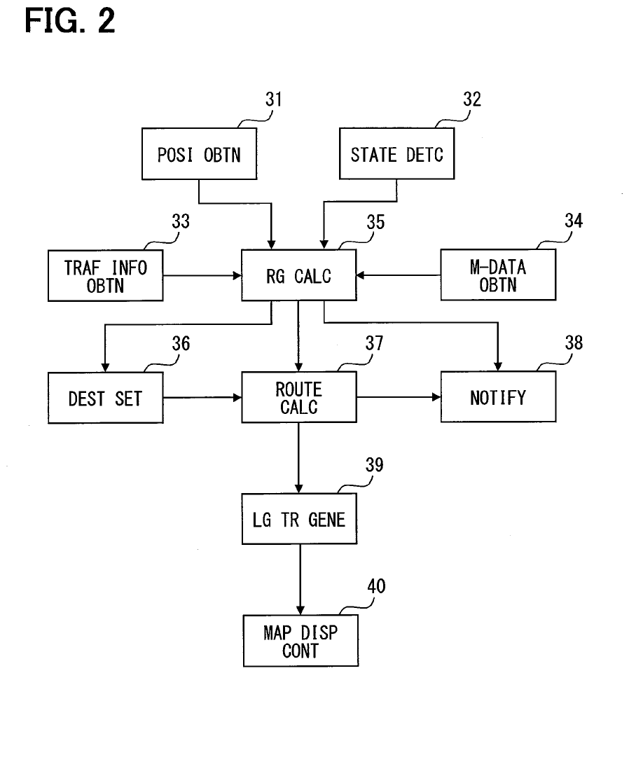

The following will describe functional blocks of the controller 26, which are related to the navigation function, with reference to FIG. 2. As shown in FIG. 2, as the functional blocks related to the navigation function, the controller 26 includes a vehicle position obtaining section (POSI OBTN) 31, a battery state detection section (STATE DETC) 32, a traffic information obtaining section (TRAF INFO OBTN) 33, a map data obtaining section (M-DATA OBTN) 34, an available travel range calculation section (RG CALC) 35, a destination setting section (DEST SET) 36, a route calculation section (ROUTE CALC) 37, a notification generating section (NOTIFY) 38, a light beam locus generating section (LG TR GENE) 39, and a map display control section (MAP DISP CONT) 40.

The vehicle position obtaining section 31 obtains the present position of the vehicle from the position detector 11, converts the present position based on world geodetic system, and outputs the converted coordinates of the present position. The battery state detection section 32 obtains the SOC of the travelling battery of the vehicle and detects the remaining power storage of the travelling battery and outputs information related to the detected remaining power storage. The vehicle position obtaining section 31 functions as a position obtaining section.

The traffic information obtaining section 33 obtains the road traffic information from the communication device 25. The communication device 25 receives the road traffic information distributed by, for example, the VICS center. The map data obtaining section 34 obtains map data input by the map data input unit 16. The map data obtaining section 34 may also receive high-accuracy map data from the communication device 25. Herein, the communication device 25 receives the high-accuracy map data distributed by the distribution server of the ADAS Horizon. The map data obtaining section 34 functions as a road property obtaining section and a charging facility information obtaining section.

The map data obtaining section 34 obtains an estimated time for passing through a link based on travel history of the subject vehicle and other vehicles. The travel history stored in the subject vehicle may be obtained as the travel history of the subject vehicle. The travel history of other vehicles may be obtained from other vehicles by a vehicle-to-vehicle communication or from a center by a vehicle-to-roadside communication.

The available travel range calculation section 35 estimates, based on the remaining power detected by the battery state detection section 32, the travel distance which the vehicle is able to travel (hereinafter, referred to as available travel distance) and the estimated depletion time of the remaining power of the travelling battery (hereinafter, referred to as available travel time). Hereinafter, available travel range includes at least one of the available travel distance or the available travel time. For example, the available travel range calculation section 35 may estimate the available travel distance based on the remaining power of the travelling battery detected by the battery state detection section 32 and an average power consumption of the travelling battery for travelling a unit distance. The available travel range calculation section 35 may estimate the available travel time based on the remaining power of the travelling battery detected by the battery state detection section 32 and an average power consumption of the travelling battery during a unit time period travelling.

For example, the average power consumption of the travelling battery for travelling the unit distance may be calculated based on the distance has been traveled by the vehicle and a corresponding change rate of the remaining power of the travelling battery. The traveled distance is calculated based on the vehicle positions subsequently detected by the position detector 11. The remaining power of the travelling battery is subsequently detected by the battery state detection section 32. The traveled distance may also be calculated based on a detection result of the speed sensor 14. For example, the average power consumption of the travelling battery for traveling the unit time period may be calculated based on time duration measured by, for example, a time measuring unit (not shown) and the corresponding change rate of the remaining power of the travelling battery subsequently detected by the battery state detection section 32.

The available travel range calculation section 35 may estimate the available travel distance or the available travel time with consideration of weather, temperature, use of an air conditioning device or other specific states. As will be described later, when a recommended route exists, the available travel range calculation section 35 calculates the available travel distance or the available travel time with consideration of the link data of the recommended route, road traffic information related to the recommended route, or the road class of the recommended route.

The available travel range calculation section 35 calculates power consumption amount corresponding to the road property based on the road traffic information and the map data of the ADAS Horizon, with reference to a correspondence relation (hereinafter, referred to as reference information) between the road property and the power consumption amount required for travelling a road (that is, link) having the road property. The road traffic information is obtained by the traffic information obtaining section 33. The map data of the ADAS Horizon is obtained by the map data obtaining section 34.

In the present disclosure, the road property includes the road property included in the map data of ADAS Horizon (hereinafter, referred to as ADAS road property), and further includes a congested road section, a traffic regulated road section, or a freezing condition of a road surface. As described above, the map data of ADAS Horizon includes the curvature of the curve, the road width, the road slope, the number of traffic lanes of the road, the speed limit, and the road class. The reference information is stored in a non-volatile memory of the controller 26. Thus, the controller 26 functions as the correspondence relation storing section.

For example, in the reference information, a power consumption amount lower than a default value, for example, the average power consumption amount may be correlated to a road property of a road on which energy regeneration frequently occurs. For example, to an ordinary road on which the energy regeneration frequently occurs, a junction, a curve having a curvature greater than a predetermined value, a lower power consumption amount may be correlated to. On the other hand, to an expressway on which the energy regeneration does not occur, a default value of the power consumption amount may be correlated to.

When the curvature of the curve increases, more braking force is required and energy regeneration may increase. Thus, the power consumption amount to be correlated to the road may be decreased with an increase of the curvature of the curve. A road having a low frictional coefficient (p) may require frequent brake operations of the vehicle. Thus, when the road surface is frozen, a power consumption amount lower than the default value may be correlated to the road.

An upward slope of the road requires more power consumption amount than a flat road and a downward slope of the road requires less power consumption amount than the flat road. Thus, the power consumption amount to be correlated to the upward road may be increased with an increase of a slope degree of the upward road, and the power consumption amount to be correlated to the downward road may be decreased with an increase of a slope degree of the downward road.

The available travel range calculation section 35 calculates a travel time of the link (hereinafter, referred to as a link travel time) based on the required time included in the road traffic information that is subsequently obtained and the travel history. The power consumption amount corresponding to the road property and the link travel time are calculated every when the road traffic information and the map data of ADAS Horizon are newly obtained.

For example, after the vehicle departs from a departure point, the available travel range calculation section 35 may subsequently calculate the available travel distance or the available travel time corresponding to the road traffic information, map data of ADAS Horizon, and travel state of the vehicle. The road traffic information, the map data of ADAS Horizon, and the travel state of the vehicle are subsequently obtained. The departure point is a position at which an ignition switch of the vehicle is powered on.

The destination setting section 36, the route calculation section 37, and the notification generating section 38 execute processes with consideration of the power consumption amount, the available travel distance, and the available travel time, based on the available travel distance and the available travel time calculated by the available travel range calculation section 35, the power consumption amount corresponding to the road property, or the link travel time corresponding to the road property.

The destination setting section 36 sets a position selected by the user with the operation switch group 21 or with the remote control terminal 22 as the destination. The destination setting section 36 sets the destination with consideration of the available travel distance or the available travel time. For example, the destination setting section 36 sets a position that enables a return trip to the departure point as the destination. As another example, the destination setting section 36 sets a position to which the vehicle is able to travel with predetermined power consumption amount as the destination.

When the destination is set by the destination setting section 36, the route calculation section 37 searches for a recommended route from the departure point (for example, the vehicle position) to the destination using a well-known method. The route calculation section 37 functions as a route retrieval section. When retrieving the recommend route, giving a priority to power consumption suppression may be selected as a retrieval condition in addition to an ordinary retrieval condition, such as giving a priority to the travel distance or to the travel time.

When giving the priority to the power consumption suppression is selected as the retrieval condition, the route calculation section 37 searches for the recommended route which requires a power consumption amount to the destination within a predetermined range. As another example, when giving the priority to the power consumption suppression is selected as the retrieval condition, the route calculation section 37 may search for the recommended route which enables a return trip to the departure point after arriving at the destination with the remaining power of the travelling battery.

In the present embodiment, as described above, when traveling along the route, the route calculation section 37 is able to accurately estimate the power consumption amount based on the power consumption amount corresponding to the road property, and is able to accurately estimate the travel time based on the link travel time corresponding to the road property. Thus, the route calculation section 37 is able to accurately determine the recommended route that requires the power consumption amount to the destination limited within the predetermined range, or is able to accurately determine the recommended route that enables the return trip to the departure point after arriving at the destination with the remaining power of the travelling battery. Thus, the user who drives the electric vehicle with consideration of the available travel distance may feel less psychological burden when departing for the destination. That is, the psychological burden of the user is reduced.

After departing from the departure point, the available travel range calculation section 35 subsequently calculates, at the present position of the vehicle, the available travel distance or the available travel time. After departing from the departure point, the route calculation section 37 subsequently calculates, at the present position of the vehicle, an estimation available travel distance or an estimation available travel time. The route calculation section 37 estimates the estimation available travel distance or the estimation available travel time based on the available travel distance or the available travel time calculated at the departure point. The route calculation section 37 functions as an estimation available travel range calculation section. The route calculation section 37 calculates a progress of the available travel distance or the available travel time at the present position with respect to the estimation available travel distance or the estimation available travel time at the present position. Herein, a progress means an increase or a decrease of the available travel distance or the available travel time at the present position with respect to the estimation available travel distance or the estimation available travel time at the present position. The route calculation section 37 functions as a progress calculation section. The estimation available travel distance or the estimation available travel time is calculated by subtracting the travel distance or the travel time from the departure point to the present position from the available travel distance at the departure point or from the available travel time at the departure point. The available travel distance at the departure point or the available travel time at the departure point is calculated by the available travel range calculation section 35 at the departure point.

Information related to the progress (hereinafter, referred to as progress information) of the available travel distance with respect to the estimation available travel distance is equal to increased amount or decreased amount of the available travel distance with respect to the estimation available travel distance. Information related to the progress (hereinafter, referred to as progress information) of the available travel time with respect to the estimation available travel time is equal to increased amount or decreased amount of the available travel time with respect to the estimation available travel time.

(First Modification)

The following will describe a first modification of the present embodiment. The route calculation section 37 pre-reads, at the present position based on the available travel distance at the present position or the available travel time at the present position, an available travel distance or an available travel time at a forward end of a link corresponding to a forward road in a travelling direction of the vehicle. Specifically, the route calculation section 37 calculates the power consumption amount required for traveling from the present position to the forward end of the link corresponding to the forward road based on the ADAS road property or the road traffic information. Herein, the ADAS road property or the road traffic information is obtained by the map data obtaining section 34, which functions as the road property obtaining section. Then, the route calculation section 37 calculates a travel distance or a travel time corresponding to the calculated power consumption amount. Then, the route calculation section 37 calculates, beforehand at the present position, the available travel distance at the forward end of the link corresponding to the forward road or the available travel time at the forward end of the link corresponding to the forward road, based on the available travel distance or the available travel time of the present position and the travel distance or the travel time corresponding to the power consumption amount required for travelling from the present position to the forward end of the link corresponding to the forward road. The route calculation section 37 calculates, beforehand at the present position, the estimation available travel distance at the forward end of the link corresponding to the forward road or the estimation available travel time at the forward end of the link corresponding to the forward road, based on the available travel distance or the available travel time of the present position by a simple calculation. The available travel distance at the forward end of the link corresponding to the forward road or the available travel time at the forward end of the link corresponding to the forward road is calculated by subtracting the travel distance or the travel time corresponding to the power consumption amount required for travelling from the present position to the forward end of the link corresponding to the forward road from the available travel distance or the available travel time at the present position. The estimation available travel distance or the estimation available travel time at the forward end of the link corresponding to the forward road is calculated by subtracting the distance from the present position to the forward end of the link corresponding to the forward road or the time required for travelling the distance from the present position to the forward end of the link corresponding to the forward road without consideration of the ADAS road property or the road traffic information from the available travel distance or the available travel time of the present position. Then, the route calculation section 37 calculates, beforehand at the present position, the progress, such as increase amount or decrease amount of the available travel distance or the available travel time of the forward end of the link corresponding to the forward road with respect to the estimation available travel distance or the estimation available travel time of the forward end of the link corresponding to the forward road.

When the recommended route is retrieved, the route calculation section 37 further subsequently retrieves substitute routes, and calculates a distance to a branch point which is disposed on the recommended route and guides to the substitute route (hereinafter, referred to as a branch point arrival distance) or a time required for travelling to the branch point that guides to the substitute route (hereinafter, referred to as a branch point arrival time).

The substitute route is a route that guides the user to the destination other than the recommended route. The substitute route may be a route that guides the user to the destination without guidance to a dead end or without going back with reference to the present position, or may be a route that guides the user to the destination with the remaining power of the travelling battery.

In the present embodiment, the substitute route is supposed as any route that guides the user to the destination with the remaining power of the travelling battery. The route that guides the user to the destination with the remaining power of the travelling battery may be retrieved by using the link travel time of each link connected with the link corresponding to the forward road of the vehicle and the available travel time. The route that guides the user to the destination with the remaining power of the travelling battery may also be retrieved by a length of each link connected with the link corresponding to the forward road of the vehicle and the available travel distance.

The route calculation section 37 searches for the charging stations disposed within a reachable range from the present position of the vehicle, and calculates a distance to the closest one of the charging stations. The charging station disposed within the reachable range from the present position of the vehicle is a charging station disposed within a predetermined range to which the vehicle is able to travel with the remaining power of the travelling battery.

The notification generating section 38 performs a notification to attract an attention of the driver at a proper timing by adjusting the available travel distance, the available travel time, the distance or time required for travelling to the branch point that guides to the substitute route, the progress information, the audio route guidance and the route guidance display. Details of the adjustment will be described as the following. When the available travel distance, the available travel time, the distance or the time for travelling to the branch point that guides to the substitute route is equal to or lower than respective predetermined threshold values, that is, notifying the user of the available travel distance, the available travel time, the distance or the time for travelling to the branch point with higher priority than the audio route guidance or the route guidance display, the available travel distance, the available travel time, the distance or the time for travelling to the branch point that guides to the substitute route are notified to the user by interrupting the audio route guidance or the route guidance display. If a charging station exists around the present position of the vehicle, the charging station is also notified to the driver.

The light beam locus generating section 39, based on the progress information obtained from the route calculation section 37, generates the light beam locus along the travelling direction of the vehicle with the present position of the vehicle as a base. The travelling direction of the vehicle may be obtained by the position detector 11.

The light beam locus has a sector-like shape which is a shape generated when lights emitted from a point light source are projected on a road surface ahead of the vehicle. The shape of the light beam locus is similar to a shape when lights emitted from a headlight of the vehicle are projected on the road surface ahead of the vehicle. The light beam locus has the sector-like shape, but is not limited to an exact sector shape. That is, the light beam locus is not limited to a shape generated by dividing a circle with two radiuses. The light beam locus may include arcs having a curvature different from a curvature of an arc generated by dividing a circle with two radiuses.

The light beam locus generating section 39 changes, regardless of the scale of the electronic map, a length of the light beam locus along a longitudinal direction corresponding to the progress information in the map display from a default area so that the light beam locus is entirely displayed on a display window of the display device 19. Herein, the longitudinal direction is a direction along the travelling direction of the vehicle.

When the progress information indicates that the available travel distance or the available travel time is increased with respect to the estimation available travel distance or the estimation available travel time, the light beam locus generating section 39 increases the longitudinal length of the light beam locus from a default length. When the progress information indicates that the available travel distance or the available travel time is decreased with respect to the estimation available travel distance or the estimation available travel time, the light beam locus generating section 39 decreases the longitudinal length of the light beam locus from the default length.

When the light beam locus generating section 39 changes the longitudinal length of the light beam locus, the light beam locus generating section 39 may increase or decrease the longitudinal length of the light beam locus corresponding to the increase amount or the decrease amount of the available travel distance or the available travel time in stepwise manner. When the available travel distance or the available travel time is increased, the longitudinal length of the light beam locus may be increased by a predetermined length regardless of the increase amount of the distance or the time. When the available travel distance or the available travel time is decreased, the longitudinal length of the light beam locus may be decreased by a predetermined length regardless of the decrease amount of the distance or the time.

When the substitute route exists within a predetermined area, the light beam locus generating section 39 changes, regardless of the scale of the electronic map, a length of the light beam locus (that is, an opening degree) along a lateral direction corresponding to a direction toward the branch point that guides to the substitute route but in the map display from a default area under a condition that the light beam locus is entirely displayed on the display window of the display device 19. Herein, the lateral direction is perpendicular to the longitudinal direction. The length of the light beam locus along the lateral direction is also referred to as an opening width of the light beam locus along the lateral direction. The opening width of the light beam locus along the lateral direction has an upper limitation of 180 degrees.

For example, the opening width of the light beam locus along the lateral direction toward the substitute route may be set according to a degree of an azimuth of the substitute route at the branch point with respect to the travelling direction of the vehicle. Herein, the lateral direction is a right-left direction with reference to the travelling direction of the vehicle.

Even when the substitute route does not exist and the recommended route is not searched for, the light beam locus generating section 39 may change, regardless of the scale of the electronic map, a length of the light beam locus along the lateral direction corresponding a branch direction which is a direction pointing a branch point (for example, a closest intersection) disposed within a predetermined forward area, in the map display from the default area.

(Second Modification)

The following will describe a second modification of the present embodiment. The light beam locus generating section 39 may increase the opening width of the light beam locus along the lateral direction from the default area with an increase of the number of the roads branching off from the branch point (for example, the closest branch point) disposed within the predetermined forward area with respect to the present position of the vehicle. The light beam locus generating section 39 may increase the opening width of the light beam locus along the lateral direction from the default area with an increase of the number of the branch points to the substitute road. Herein, the branch points are disposed within the predetermined forward area with respect to the present position of the vehicle.

The map display control section 40 displays, on the display device 19, the light beam locus generated by the light beam locus generating section 39 together with the well-known navigation display, such as electronic map for the navigation, an icon indicating the present position of the vehicle, in an overlapped manner. The map display control section 40 functions as a display controller. The area display of the light beam locus is drawn on the electronic map. The area display of the light beam locus needs an independent control from a control of the navigation function. Thus, the area display of the light beam locus is drawn on a layer different from a layer on which the icon of the vehicle position or the electronic map is drawn.

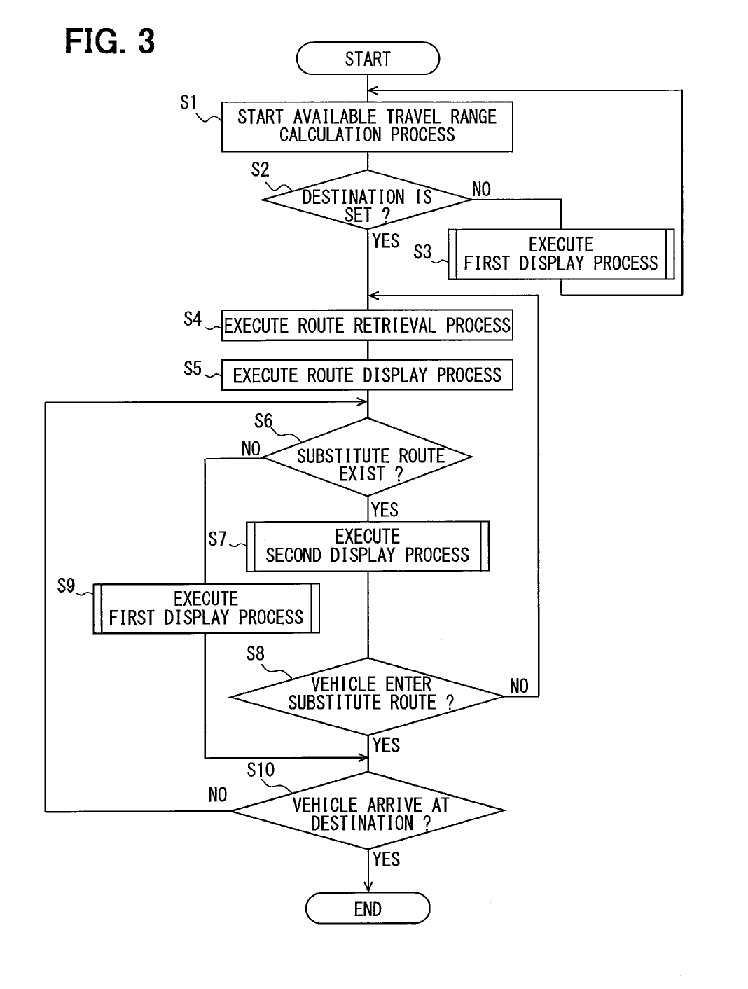

The following will describe a route guidance process executed by the controller 26 for the electric vehicle with reference to a flowchart shown in FIG. 3. The controller 26 executes the process shown in FIG. 3 in response to, for example, power on of the ignition switch of the vehicle. The controller 26 subsequently obtains the present position of the vehicle detected by the position obtaining section 31, and subsequently obtains the remaining power of the travelling battery detected by the battery state detection section 32.

At S1, the controller 26 starts an available travel range calculation process, and proceeds to S2. In the available travel range calculation process, the available travel range calculation section 35 calculates the available travel distance or the available travel time at the departure point as described above. The departure point is a point at which the ignition switch is powered on. The available travel range calculation process is subsequently executed after the vehicle departs from the departure point, and updates the available travel distance or the available travel time corresponding to the present position of the vehicle.

At S2, when the destination is set by the destination setting section (S2: YES), the controller 26 proceeds to S4. At S2, when the destination is not set by the destination setting section 36 (S2: NO), the controller 26 proceeds to S3.

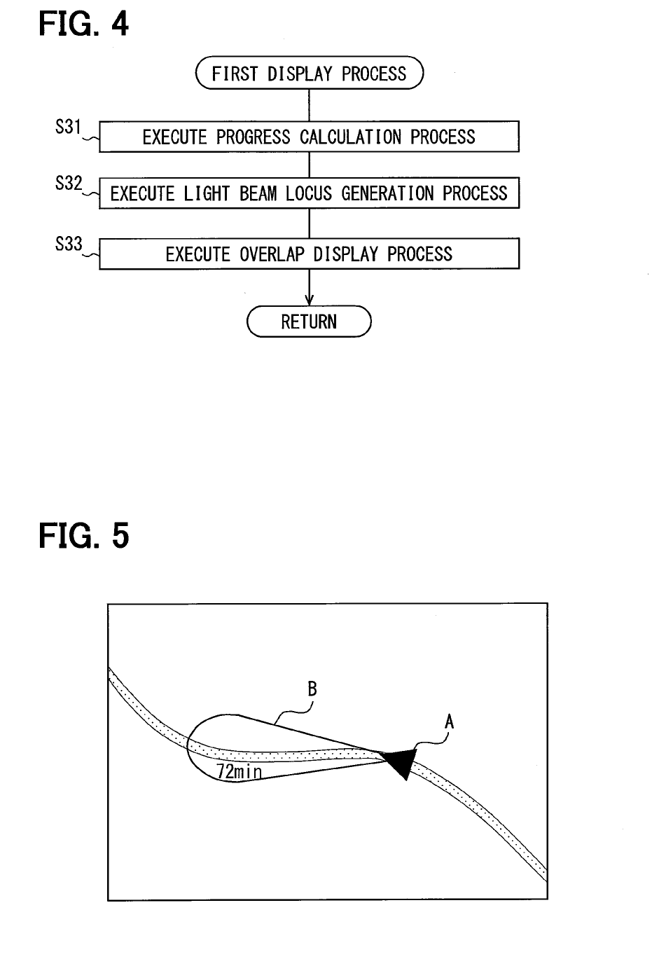

At S3, the controller 26 executes a first display process, and then returns to S1 and repeatedly execute the above-described process. The following will describe the first display process executed by the controller 26 with reference to a sub flowchart shown in FIG. 4.

At S31, the controller 26 executes a progress calculation process, and then proceeds to S32. As describe above, in the progress calculation process, the route calculation section 37 calculates a progress of the available travel distance or the available travel time at the present position with respect to the estimation available travel distance or the estimation available travel time estimated based on the available travel distance or the available travel time of the departure point. As describe above, in the progress calculation process, when the vehicle travels the forward road in the travelling direction, the route calculation section 37 may pre-read a progress of the available travel distance or the available travel time at the forward end of the link corresponding to the forward road with respect to the estimation available travel distance or the estimation available travel time at the forward end of the link corresponding to the forward road.

At S32, the controller 26 executes a light beam locus generation process, and then proceeds to S33. As describe above, in the light beam locus generation process, the light beam locus generating section 39 generates the light beam locus based on the progress information calculated by the progress calculation process at S31. In the light beam locus generation process, when the longitudinal length of the light beam locus needs to be changed corresponding to the progress, the longitudinal length of the light beam locus is changed when generating the light beam locus.

At S33, the controller 26 executes an overlap display process, and then returns to S4. In the overlap display process, the map display control section 40 displays the area display of the light beam locus generated by the light beam locus generating section 39 together with the electronic map around the present position of the vehicle in an overlapped manner on the display window of the display device 19. When the light beam locus whose length in the longitudinal direction has been changed is generated in the light beam locus generation process, the area display of the light beam locus is displayed on the display device 19 so that the length of the light beam locus along the longitudinal direction is changed in the overlap display process.

In the overlap display process, the map display control section 40 may display, for example, the vehicle position icon, the remaining power of the travelling battery, the available travel distance or the available travel time at the present position, a text indicating the progress information calculated in the progress calculation process at S31 together with the electronic map around the vehicle position on the display device 19.

For example, the map display control section 40 may display the remaining power of the travelling battery, the available travel distance or the available travel time at the present position, the text indicating the progress information calculated in the progress calculation process at S31 together with the area display of the light beam locus in an overlapped manner on the display window of the display device 19.

The following will describe a display example when the present available travel time (that is, the estimated depletion time of the remaining power of the travelling battery) calculated in the available travel range calculation process is displayed together with the area display of the light beam locus in an overlapped manner, with reference to FIG. 5. In FIG. 5, A is a vehicle position icon and B is the area display of the light beam locus. In FIG. 5, the text of “72 min” indicates the estimated depletion time of the remaining power of the travelling battery.

The remaining power of the travelling battery, the present available travel distance or the present available travel time, the progress information calculated in the progress calculation process at S31 may also be notified to the user by outputting an audio notification from the audio output unit 20. Herein, the outputting of the audio notification is controlled by the notification generating section 38.

Return to FIG. 3, at S4, the controller 26 executes a route retrieval process, and then proceeds to S5. As described above, in the route retrieval process, the route calculation section 37 searches for the recommended route from the departure point (from the present position after departure) to the destination.

At S5, the controller 26 executes a route display process, and then proceeds to S6. In the route display process, the map display control section 40 displays the destination set by the destination setting section 36 and the recommended route retrieved by the route calculation section 37 on the electronic map around the vehicle position.

As described above, at S6, the route calculation section 37 searches for the substitute route. When the branch point (that is, the intersection) that guides to the substitute route exists within the predetermined area around the vehicle position (S6: YES), the process proceeds to S7. When the branch point that guides to the substitute route does not exist within the predetermined area around the vehicle position (S6: NO), the process proceeds to S9.

The predetermined area with respect to the vehicle position may be a circular range with the vehicle position as a circle center and having a predetermined radius. The predetermined area with respect to the vehicle position may also be an area on the forward road along the travelling direction of the vehicle within a predetermined distance from the present position of the vehicle.

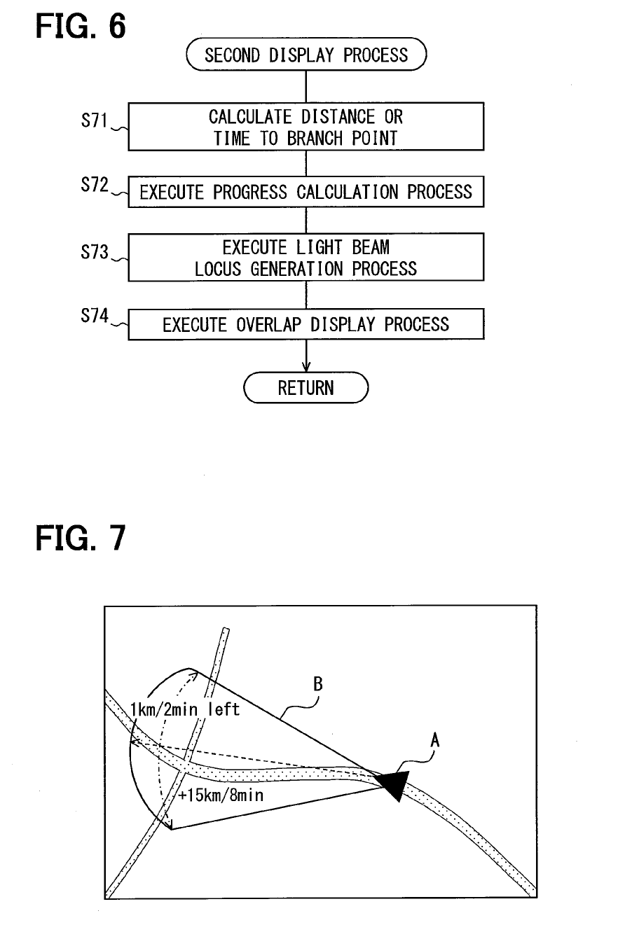

At S7, the controller 26 executes a second display process, and then proceeds to S8. The following will describe the second display process executed by the controller 26 with reference to a sub flowchart shown in FIG. 6.

As described above, at 571, the route calculation section 37 calculates the distance or the time for arriving at the branch point, and proceeds to S72.

At S72, the controller 26 executes a progress calculation process, and proceeds to S73. As describe above, in the progress calculation process, the route calculation section 37 calculates a progress of the available travel distance or the available travel time at the present position with respect to the estimation available travel distance or the estimation available travel time at the present position. The estimation available travel distance or the estimation available travel time at the present position is estimated based on the available travel distance or the available travel time of the departure point. As describe above, in the progress calculation process, when the vehicle travels the forward road in the travelling direction, the route calculation section 37 may pre-read, at the present position, a progress of the available travel distance or the available travel time at the forward end of the link corresponding to the forward road with respect to the estimation available travel distance or the estimation available travel time at the forward end of the link corresponding to the forward road.

At S73, the controller 26 executes a light beam locus generation process, and then proceeds to S74. As describe above, in the light beam locus generation process, the light beam locus generating section 39 generates the light beam locus based on the progress information calculated by the progress calculation process at S72 and the branch direction of the substitute route.

In the light beam locus generation process of S73, when the longitudinal length of the light beam locus needs to be changed corresponding to the progress, the longitudinal length of the light beam locus is changed when generating the light beam locus. Further, when the opening width of the light beam locus along the lateral direction needs to be changed corresponding to the branch direction of the substitute route, the opening width of the light beam locus along the lateral direction is changed when generating the light beam locus.

At S74, the controller 26 executes an overlap display process, and then returns to S8. In the overlap display process, the map display control section 40 displays the area display of the light beam locus generated by the light beam locus generating section 39 together with the electronic map around the present position of the vehicle in an overlapped manner on the display device 19. When the light beam locus whose length in the longitudinal direction or the opening width in the lateral direction has been changed is generated in the light beam locus generation process, the area display of the light beam locus is displayed on the display device 19 so that the length of the light beam locus along the longitudinal direction or the opening width of the light beam locus along the lateral direction is changed in the overlap display process.

In the overlap display process, the map display control section 40 may display, for example, the vehicle position icon, the remaining power of the travelling battery, the available travel distance or the available travel time at the present position, multiple texts indicating the progress information calculated at the progress calculation process of S72, the distance or the time required for arriving at the branch point, and a general direction of right or left on which the branch point is disposed together with the electronic map around the vehicle position on the display device 19.

For example, the map display control section 40 may display the remaining power of the travelling battery, the available travel distance or the available travel time at the present position, the texts indicating the progress information calculated at the progress calculation process of S72, the distance or the time required for arriving at the branch point, and the general direction of right or left on which the branch point is disposed together with the area display of the light beam locus in an overlapped manner on the display device 19.

FIG. 7 shows an example in which the progress information, the necessary travel distance and the necessary travel time to the branch point, and the general direction on which the branch point is disposed are displayed together with the area display of the light beam locus in an overlapped manner. In FIG. 7, A is a vehicle position icon and B is the area display of the light beam locus. In FIG. 7, the text “+15 km/8 min” indicates the progress information, and the text “1 km/2 min left” indicate the distance and the time required for arriving at the branch point and the direction on which the branch point is disposed.

The remaining power of the travelling battery, the present available travel distance or the present available travel time, the progress information calculated in the progress calculation process of S72, the distance or the time required for arriving at the branch point, and the general direction on which the branch point is disposed may also be notified to the user by outputting an audio guidance from the audio output unit 20. Herein, the outputting of the audio guidance is controlled by the notification generating section 38.

Return to FIG. 3, at S8, the controller 26 determines whether the vehicle enters the substitute route. The controller 26 may compare the present position of the vehicle which is subsequently obtained by the position obtaining section 31 with the map data when determining whether the vehicle enters the substitute route or not.

When the controller 26 determines that the vehicle has entered the substitute route (S8: YES), the controller 26 returns to the route retrieval process at S4. Then, the controller 26 newly searches for the recommended route that connected with the substitute route to which the vehicle has entered, and repeatedly executes the above-described processes. When the controller 26 determines that the vehicle has not entered the substitute route (S8: NO), the controller 26 returns to S10.

The controller 26 proceeds to S9 when the branch point that guides to the substitute route does not exist within the predetermined area with respect to the vehicle position. At S9, the controller 26 executes the first display process, and proceeds to S10.

At S10, the controller 26 determines whether the vehicle has arrived at the destination or not. The controller 26 may determine whether the vehicle has arrived at the destination based on the vehicle position subsequently obtained by the position obtaining section 31 and the coordinate of the destination. When the controller 26 determines that the vehicle has arrived at the destination (S10: YES), the controller 26 ends the process. When the controller 26 determines that the vehicle has not arrived at the destination (S10: NO), the controller 26 returns to S6, and repeatedly perform the above-described process.

In the present embodiment, the increase amount or the decrease amount of the available travel distance or the available travel time of the electric vehicle with respect to the estimation available travel distance or the estimation available travel time is displayed using an increase or a decrease of the longitudinal length of the light beam locus with the vehicle position as the base. A width of the light beam locus along the lateral direction increases in the travelling direction of the vehicle, and the light beam locus is displayed on the electronic map in an overlapped manner. Further, the increase amount or the decrease amount of the available travel distance or the available travel time of the electric vehicle at a future time (forward end of the link corresponding to the forward road) with respect to the estimation available travel distance or the estimation available travel time is displayed using an increase or a decrease of the longitudinal length of the light beam locus with the vehicle position as the base. Also in this case, a width of the light beam locus along the lateral direction increases in the travelling direction of the vehicle, and the light beam locus is displayed on the electronic map in an overlapped manner. When the increase amount or the decrease amount of the available travel distance or the available travel time is displayed using an increase or a decrease of the longitudinal length of the light beam locus, a degree by which the available travel distance or the available travel time changes in accordance with the travelling state can be notified to the user in an intuitive manner. Thus, the user who drives the electric vehicle with consideration of the available travel distance or the available travel time may feel less psychological burden with above-described configuration. That is, the psychological burden of the user is reduced.

The light beam locus has a shape similar to a projection shape of the headlight of the vehicle. The user may have get used to the light beam locus of the headlight of the vehicle, which helps the user to feel a depth or a broadness of eyesight. Thus, the user may feel a visual comfort in the travelling direction of the vehicle by overlapping the light beam locus indicating the available travel distance or the available travel time on the electronic map. Thus, the user who drives the electric vehicle with consideration of the available travel distance or the available travel time may feel less psychological burden with above-described configuration.

The light beam locus is displayed or adjusted so that the whole light beam locus is entirely displayed on the display window of the display device regardless of the scale of the electronic map. Thus, the user is no more required for performing an operation for including the whole light beam locus on the display window of the display device 19. Thus, degradation in convenience of use is restricted.

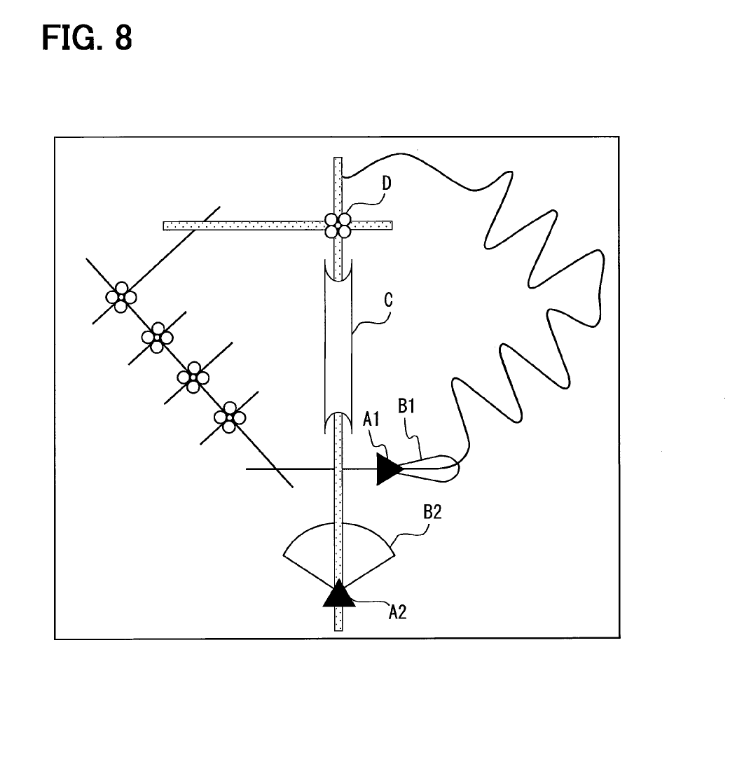

In the present embodiment, when the branch point that guides to the substitute route, that is, the intersection at which the road branches off does not exist within the predetermined area relative to the position of the vehicle, the width of the light beam locus in the lateral direction decreases and the light beam locus having a pencil beam shape (as shown in FIG. 8 by B1) is displayed. When the branch point to the substitute route, that is, the intersection at which the road branches off exists within the predetermined area relative to the position of the vehicle, the width of the light beam locus in the lateral direction increases and the light beam locus having a wide sector-like shape (as shown in FIG. 8 by B2) is displayed. Thus, the user can be notified of a degree of a route selection option in an intuitive manner. In FIGS. 8, A1 and A2 indicate the vehicle position icon, C indicates a tunnel, and D indicates a traffic light.

(Third Modification)

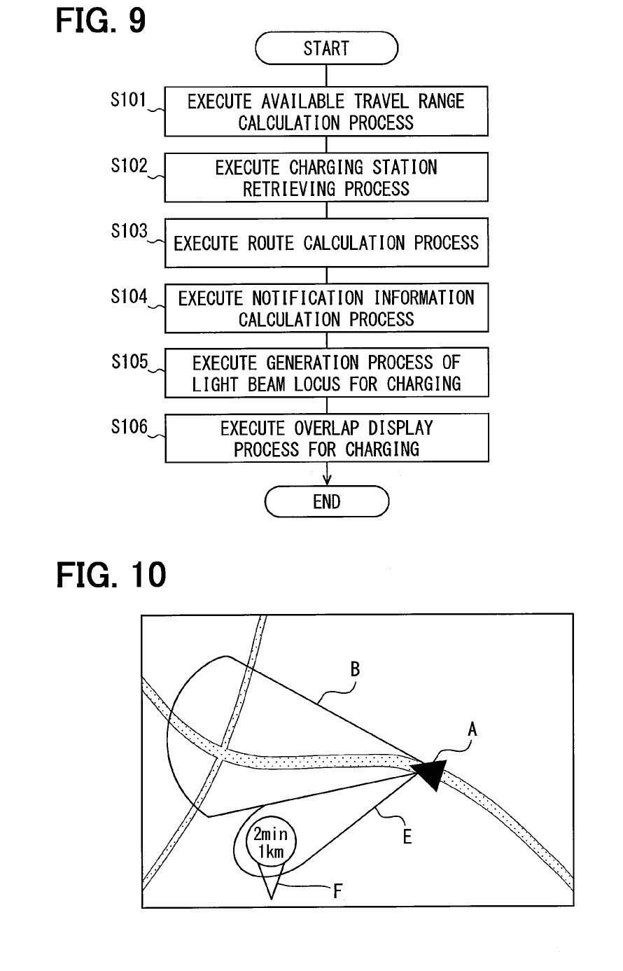

The following will describe a third modification of the present embodiment. As described above, when the charging station exists around the present position of the vehicle, the controller 26 notifies of the charging station to the user. The following will describe an example of a charging station guidance process executed by the controller 26 with reference to a flowchart shown in FIG. 9. For example, this process is executed in response to an update of the area display of the light beam locus.

At S101, similar to the above-described S1, the available travel range calculation section 35 executes the available travel range calculation process, and proceeds to S102. In the available travel range calculation process, the available travel distance or the available travel time is calculated with consideration of the congestion state or traffic regulation of the road traffic information.

At S102, the controller 26 executes the charging station retrieving process, and proceeds to S103. As described above, in the charging station retrieving process, the route calculation section 37 searches for the available charging station around the present position of the vehicle. For example, the charging station disposed within the present available travel distance is searched for based on the link travel time of each link, which is connected with the link corresponding to the forward road of the vehicle and is included within a predetermined area (for example, within 2 km with respect to the vehicle position).

The controller 26 executes a route calculation process at S103, and proceeds to S104. As described above, in the route calculation process, the route calculation section 37 calculates a route to the closest charging station from the vehicle among the charging stations that are searched for.

At S104, the controller 26 executes a notification information calculation process, and proceeds to S105. In the notification information calculation process, the route calculation section 37 calculates an azimuth of the charging station with respect to the present position of the vehicle (hereinafter, referred to as a charging azimuth), a travel time required for the vehicle to travel from the present position to the charging station (hereinafter, referred to as a charging arrival time), and a travel distance required for the vehicle to travel from the present position to the charging station (hereinafter, referred to as a charging arrival distance).

At S105, the controller 26 executes a generation process for generating a light beam locus for charging, and proceeds to S106. In the generation process of the light beam locus for the charging, the light beam locus generating section 39 newly generates the light beam locus related to the charging station (hereinafter, referred to as a light beam locus for charging). The light beam locus generating section 39 generates the light beam locus for charging so that the light beam locus for charging is displaced from a place of the area display of the original light beam locus in the travelling direction of the vehicle toward a branch point that guides to the closest charging station. The light beam locus for charging has a similar shape with the original light beam locus. The light beam locus for charging may be generated so that the light beam locus for charging faces the charging azimuth.

At S106, the controller executes an overlap display process for charging, and ends the process. In the overlap display process for charging, the map display control section 40 displays the light beam locus for charging on the electronic map in addition to the original light beam locus. In the overlap display process for charging, the map display control section may display, for example, texts indicating a name of the charging station, the charging arrival time and the charging arrival distance together with the light beam locus for charging in an overlapped manner. The name of the charging station may be obtained from the map data.

The notification generating section 38 may output an audio guidance through the audio output unit 20 to notify of the charging station name, the charging arrival time and the charging arrival distance, to the user. In the audio guidance, whether to output a speech guidance may be set by the user by operating the operation switch group 21 or by operating the remote control terminal 22. This setting is also applied to other speech guidance.

The following will describe an example of the area display of the light beam locus for charging together with the texts indicating the charging arrival time and the charging arrival distance in an overlapped manner with reference to FIG. 10. In FIG. 10, A indicates the vehicle position icon, B indicates original light beam locus, E indicates the light beam locus for charging, and F indicates the charging station icon. In FIG. 10, the text “2 min” indicates the charging arrival time, and the text “1 km” indicates the charging arrival distance.

As described above, in the third modification, the azimuth in which the closest charging station exists is displayed by the light beam locus. Thus, the position of the charging station can be notified to the user in an intuitive manner. Thus, the user who drives the electric vehicle with consideration of the available travel distance or the available travel time may feel less psychological burden with above-described configuration. Further, the charging arrival time and the charging arrival distance are displayed by the texts. Thus, the distance or the necessary time to the closest charging station can be notified to the user directly. Thus, the user who drives the electric vehicle with consideration of the available travel distance or the available travel time may feel less psychological burden with above-described configuration.

While the disclosure has been described with reference to preferred embodiments thereof, it is to be understood that the disclosure is not limited to the preferred embodiments and constructions. The disclosure is intended to cover various modification and equivalent arrangements. In addition, while the various combinations and configurations, which are preferred, other combinations and configurations, including more, less or only a single element, are also within the spirit and scope of the disclosure.

1. A navigation apparatus utilized in an electric vehicle that includes a motor and a travelling battery, the travelling battery supplying power to the motor, the navigation apparatus comprising:
a position obtaining section subsequently obtaining a present position of the electric vehicle;
a display controller displaying an electronic map on a display window of a display device;
an available travel range calculation section calculating an available travel range of the electric vehicle at the present position, the available travel range being at least one of an available travel distance that the electric vehicle is able to travel with a remaining power of the travelling battery or an available travel time that the electric vehicle is able to travel with the remaining power of the travelling battery;
an estimation available travel range calculation section calculating an estimation available travel range of the electric vehicle at the present position, the estimation available travel range being calculated based on the available travel range of the electric vehicle at a departure point of the electric vehicle, the departure point being a place from where the electric vehicle starts a travelling; and
a progress calculation section calculating an increase amount or a decrease amount of the available travel range at the present position with respect to the estimation available travel range,
wherein the display controller
displays a light beam locus on the electronic map in an overlapped manner with the present position of the electric vehicle as a base, the light beam locus has a sector-like shape spreading along a travelling direction of the electric vehicle, the sector-like shape is similar to a shape generated by lights when the lights emitted from a point light source are projected on a road surface in front of the electric vehicle, and
changes, regardless of a scale of the electronic map, a length of the light beam locus in the travelling direction corresponding to the increase amount or the decrease amount of the available travel range calculated by the progress calculation section under a condition that the light beam locus is entirely displayed on the display window of the display device.

2. The navigation apparatus according to claim 1,
wherein, when the available travel range is the available travel distance, the estimation available travel range at the present position is obtained by subtracting a travel distance of the electric vehicle from the departure point to the present position from the available travel range at the departure point, and
wherein, when the available travel range is the available travel time, the estimation available travel range at the present position is obtained by subtracting a travel time of the electric vehicle from the departure point to the present position from the available travel range at the departure point.

3. The navigation apparatus according to claim 1, further comprising:
a road property obtaining section subsequently obtaining a road property of a forward road in the traveling direction of the electric vehicle; and
a correspondence relation storing section storing a correspondence relation between the road property of the forward road and a power consumption amount required for traveling the forward road,
wherein the estimation available travel range calculation section
calculates an available travel range at a forward end of a link corresponding to the forward road based on the available travel range at the present position, the road property of the forward road, and the correspondence relation, and
calculates, without consideration of the road property of the forward road or the correspondence relation, an estimation available travel rang at the forward end of the link corresponding to the forward road only based on the available travel range at the present position, and
wherein the progress calculation section calculates, beforehand at the present position, an increase amount or a decrease amount of the available travel range at the forward end of the link corresponding to the forward road with respect to the estimation available travel range at the forward end of the link corresponding to the forward road.

4. The navigation apparatus according to claim 3,
wherein, when the available travel range is the available travel distance, the estimation available travel range at the forward end of the link corresponding to the forward road is obtained by subtracting a distance from the present position to the forward end of the link corresponding to the forward road from the available travel range at the present position, and
wherein, when the available travel range is the available travel time, the estimation available travel range at the forward end of the link corresponding to the forward road is obtained by subtracting a time necessary for travelling from the present position to the forward end of the link corresponding to the forward road without consideration of the correspondence relation between the road property of the forward road and the power consumption amount from the available travel range at the present position.

5. The navigation apparatus according to claim 1,
wherein the display controller
increases the length of the light beam locus in the travelling direction when the available travel range is increased compared with the estimation available travel range, and
decreases the length of the light beam locus in the travelling direction when the available travel range is decreased compared with the estimation available travel range.

6. The navigation apparatus according to claim 1,
wherein the display controller changes, regardless of the scale of the electronic map, a length of the light beam locus in a direction perpendicular to the travelling direction corresponding to a branch direction of a route, which branches off from the forward road and exists within a predetermined area relative to the present position of the electric vehicle, under a condition that the light beam locus is entirely displayed on the display window of the display device.

7. The navigation apparatus according to claim 1,
wherein the display controller increases, regardless of the scale of the electronic map, a length of the light beam locus in a direction perpendicular to the travelling direction with an increase of a number of routes, which branch off from the forward road and exist within a predetermined area relative to the present position of the electric vehicle, under a condition that the light beam locus is entirely displayed on the display window of the display device.

8. The navigation apparatus according to claim 1, further comprising
a charging facility information obtaining section obtaining position information of a charging facility that provides a charging service for the travelling battery,
wherein the display controller further displays, on the electronic map, a light beam locus for charging related to a route that guides to the charging facility in addition to the light beam locus displayed in the travelling direction of the electric vehicle with the present position of the electric vehicle as the base, and
wherein the light beam locus for charging is displaced, from the light beam locus, toward a branch direction in which the charging facility closest to the present position of the electric vehicle is disposed.

9. The navigation apparatus according to claim 8,
wherein the display controller displays a text indicating at least one of a distance to the charging facility disposed closest to the present position of the electric vehicle, a time required for travelling to the charging facility disposed closest to the present position of the electric vehicle, or a name of the charging facility disposed closest to the present position of the electric vehicle.

10. The navigation apparatus according to claim 1, further comprising
a route retrieval section retrieving a recommended route to a destination,
wherein, when the route retrieval section retrieves the recommended route, the display controller displays, together with the light beam locus, a text indicating at least one of a distance from the present position of the electric vehicle to a branch point or a time required for travelling from the present position of the electric vehicle to the branch point, and the branch point is a place where a different route to the destination branches off from the recommended route.

11. The navigation apparatus according to claim 1,
wherein the display controller displays, together with the light beam locus, a text indicating the increase amount or the decrease amount of the available travel range with respect to the estimation available travel range, and the increase amount or the decrease amount is calculated by the progress calculation section.

12. The navigation apparatus according to claim 1,
wherein the display controller displays, together with the light beam locus, a text indicating the available travel time during which the electric vehicle is able to travel with the remaining power of the travelling battery.
